(19) United States
(12) Patent Application Publication
(10) Pub. No.: US 2025/0378753 A1
(43) Pub. Date: Dec. 11, 2025

(54) FIRE ALERT SIGNAL MANAGEMENT METHOD AND FIRE ALERT SIGNAL DETECTION AND MANAGEMENT SYSTEM ENABLING IMPLEMENTATION OF SAID METHOD

(71) Applicants: Airbus SAS, BLAGNAC (FR); Airbus Operations SAS, TOULOUSE (FR)

(72) Inventors: Thierry CLAVEL, TOULOUSE (FR); Stéphane COTE, BLAGNAC (FR); Stéphane PUGLIESE, TOULOUSE (FR); Christine GRIS, TOULOUSE (FR); Stephane ABBAS, TOULOUSE (FR); Agnès HERMELINE, TOULOUSE (FR)

(21) Appl. No.: 19/227,660

(22) Filed: Jun. 4, 2025

(30) Foreign Application Priority Data
Jun. 7, 2024 (FR) FR2406002

(51) Int. Cl. G08B 29/04; G08B 7/06

(52) U.S. Cl. CPC G08B 29/043; G08B 7/06

(57) ABSTRACT

A method of managing fire alert signals coming from at least one fire detector configured to generate at least one fire alert signal if overheating is detected, a fault signal being generated if the fire detector is malfunctioning. The management method includes a step of determining a transitory time between the end of the fire alert signal and the start of the fault signal, and a step of emitting an alert signal if the transitory time is less than or equal to an alert threshold time. This solution enables reliable determination if the end of the fire alert signal is the result of extinction of the fire or malfunctioning of the fire detector. A system for executing the method is also provided.

### CROSS-REFERENCES TO RELATED APPLICATIONS

This application claims the benefit of French Patent Application Number FR2406002 filed on Jun. 7, 2024, the entire disclosures of which are incorporated herein by way of reference.

### FIELD OF THE INVENTION

The present invention relates to a fire alert signal management method, a fire alert signal detection and management system enabling implementation of the method and an aircraft including the system.

### BACKGROUND OF THE INVENTION

In a prior art embodiment seen in FIG. 1 an aircraft 10 includes a fire alert signal detection and management system 12 that includes fire detectors 14 each configured to generate a fire alert signal positioned in the main power units 16 and the auxiliary power unit 18 of the aircraft 10 and a processing system 20 configured to process the fire alert signals and, depending on the signals received, to emit an alert signal transmitted to audible and/or visual alarms 22 situated in the cockpit of the aircraft 10 or retranscribed onto a display situated in the cockpit.

In an embodiment seen in FIG. 2 a main power unit 16 includes, inter alia, an engine core 16.1, a fan and a fan casing 16.2. The fire alert signal detection and management system 12 includes at the level of each main power unit 16 fire detectors 14.1 to 14.4 positioned, for example, at the level of a compartment situated around the engine core 16.1 and a compartment situated around the fan casing 16.2. Additionally, the fire alert signal detection and management system 12 comprises a processing system 20, two detection channels 24.1, 24.2 configured to transmit the fire alert signals emitted by the fire detectors 14.1 to 14.4 to the processing system 20, and audible and visual alarms 22.1, 22.2. The presence of two detection channels 24.1, 24.2 enables routing of fire alert signals to the processing system 20, even if one of them is damaged.

In an operating mode seen in FIG. 3, each fire detector 14 is configured to emit a fire alert signal S1 via one of the detection channels 24.1, 24.2 that has a first reference value V_{1.0} in the absence of fire and a first detection value V_{1.1} if the fire detector 14 detects overheating above a threshold level. Each fire detector 14 is designed to function during a fire for at least a minimal functioning time of the order of five minutes. Thus, the fire alert signal S1 has a value equal to the first detection value V_{1.1} as long as the overheating detected by the fire detector 14 is at or above the threshold level and the fire detector 14 is able to function. If the overheating drops below the threshold level (which corresponds to the end of the fire) or if the fire detector 14 or its detection channel 24.1, 24.2 is no longer functional the fire alert signal S1 has a value equal to the first reference value V_{1.0} or the fire detector 14 no longer emits any fire alert signal S1, which corresponds to a value equal to 0.

Additionally, each fire detector 14 is associated with a fault detector 28.1 to 28.4 configured to emit a fault signal S2 that has a second reference value V_{2.0} when the fire detector 14 is functioning correctly and a second malfunction value V_{2.1} if the fire detector 14 is malfunctioning.

In one operating mode the processing system 20 is configured to receive the fire alert signals from each detection channel 24.1, 24.2 and to combine them in a logical manner in order to emit an alarm signal.

If a first engine fire occurs at the level of a first main power unit, a first fire detector 14.x of the fire detectors 14.1 to 14.4 detects abnormal overheating and emits a fire alert signal S1 that has a value equal to the first detection value V_{1.1}. The first fire detector 14.x can be damaged if this first fire lasts more than five minutes. In this case, the fault detector 28.x associated with the first fire detector 14.x emits a fault signal S2 that has a value equal to the second malfunction value V_{2.1}.

Given that the first fire detector 14.x is no longer functional, the crew of the aircraft 10 no longer has reliable and direct information for determining if the first fire is persisting or if a second fire has ignited after extinction of the first fire.

The crew can try to verify if the main power unit 16 is on fire by viewing it through a window in the cockpit or cabin. However, this visual check is not always possible and reliable.

Information relating to the parameters of the main and auxiliary power units 16, 18 available in the cockpit can assist the pilot to determine if the first fire is persisting or if a new fire has started. However, this information is spread around in the cockpit and is not easy to interpret.

### SUMMARY OF THE INVENTION

The present invention aims to remedy some or all of the drawbacks of the prior art.

To this end, the invention has for an object a method of managing fire alert signals coming from at least one fire detector configured to generate at least one fire alert signal if overheating is detected, a fault signal being generated if the fire detector is malfunctioning, the fire alert signal having an end, the fault signal having a start.

According to the invention, the management method comprises a step of determining a transitory time between the end of the fire alert signal and the start of the fault signal, a step of comparing the transitory time and an alert threshold time, and a step of emitting an alert signal if the transitory time is less than or equal to the alert threshold time.

Determining a transitory time between the end of the fire alert signal emitted by a fire detector and the beginning of the fault signal associated with that fire detector and comparing it to an alert threshold time makes it possible to determine reliably and objectively if the end of the fire alert signal is caused by extinction of the fire or by malfunctioning of the fire detector.

In accordance with another feature, the alert threshold time is less than or equal to one minute.

In accordance with another feature, the management method comprises, beforehand, a step of determining a functioning time of the fire alert signal and a step of triggering steps of determining the transitory time, of comparing the transitory time and the alert threshold time, and then, depending on the comparison step, a step of emitting an alert signal if the functioning time of the fire alert signal is greater than or equal to a functioning threshold time.

In accordance with another feature, the fire detector has a minimal functioning time. Additionally, the functioning threshold time is between 60% and 90% of the minimal functioning time of the fire detector.

In accordance with another feature, the management method comprises a step of triggering a visual and/or audible alarm or retranscription onto a display if the alert signal is emitted.

The invention also has for an object a fire alert signal detection and management system enabling execution of a fire alert signal management method having any of the above features.

According to the invention, the system includes at least one fire detector configured to generate at least one fire alert signal if overheating is detected, at least one processing system configured to process each fire alert signal and, for at least the fire detector, a system for detecting a malfunction configured to emit a fault signal if the fire detector is malfunctioning, the fire alert signal having an end, the fault signal having a start. Additionally, the processing system is configured to compare an alert threshold time and a transitory time between the end of the fire alert signal and the start of the fault signal and to emit an alert signal if the transitory time is less than the alert threshold time.

In accordance with another feature, the alert threshold time is less than or equal to one minute.

In accordance with another feature, the processing system is configured to determine a functioning time of the fire alert signal from the fire detector and, if the functioning time of the fire alert signal is greater than or equal to a functioning threshold time, to trigger steps of determining the transitory time, comparing the transitory time with the alert threshold time and, depending on the comparison step, emitting an alert signal.

In accordance with another feature, the fire detector has a minimal functioning time. Additionally, the functioning threshold time is between 60% and 90% of the minimal functioning time of the fire detector.

In accordance with another feature, the processing system is configured to execute a program that comprises the following instructions:
a. determining the functioning time of the fire detector,
b. comparing the functioning time so determined with a functioning threshold time associated with the fire detector,
c. if the functioning time is greater than or equal to the functioning threshold time then the program continues, if not it is halted,
d. determining a transitory time between the end of the fire alert signal emitted by the fire detector and the start of the fault signal associated with the fire detector,
e. if the transitory time is less than the alert threshold time then an alert signal is emitted, if not the program is halted.

The invention also has for an object to provide an aircraft comprising a fire alert signal detection and processing system having any of the above features.

### BRIEF DESCRIPTION OF THE DRAWINGS

Other features and advantages will emerge from the following description of the invention given by way of example only and with reference to the appended drawings, in which:

FIG. 1 is a perspective view of an aircraft,

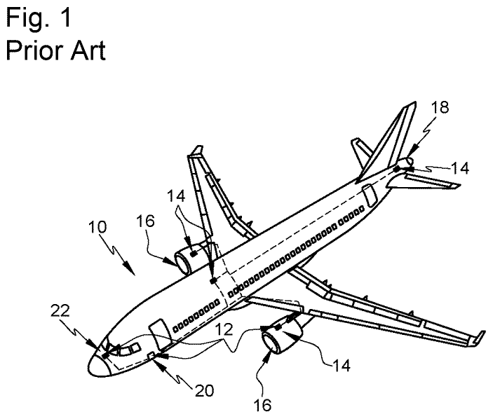

FIG. 2 is a diagrammatic representation of a main power unit and an engine fire detection and extinction system depicting a prior art embodiment,

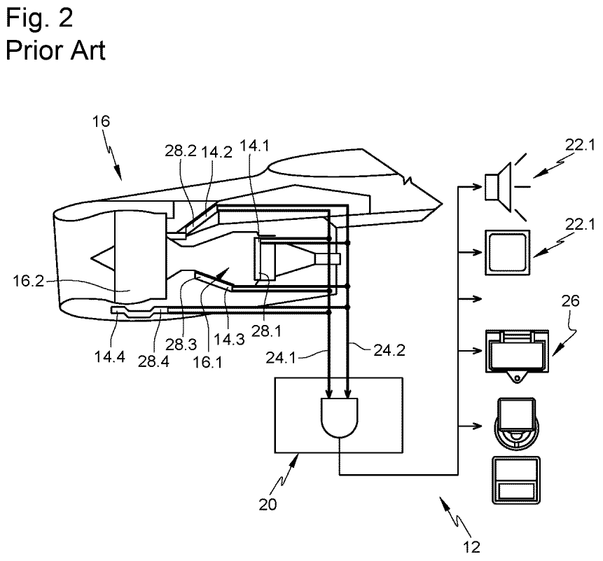

FIG. 3 is a diagrammatic representation of fire alert and fault signals depicting a prior art embodiment,

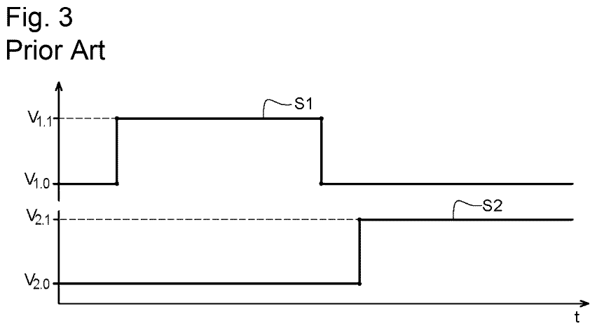

FIG. 4 is a diagrammatic representation of a fire alert signal detection and management system depicting an embodiment of the invention,

FIG. 5 is a diagrammatic representation of fire alert, fault and alert signals depicting an embodiment of the invention.

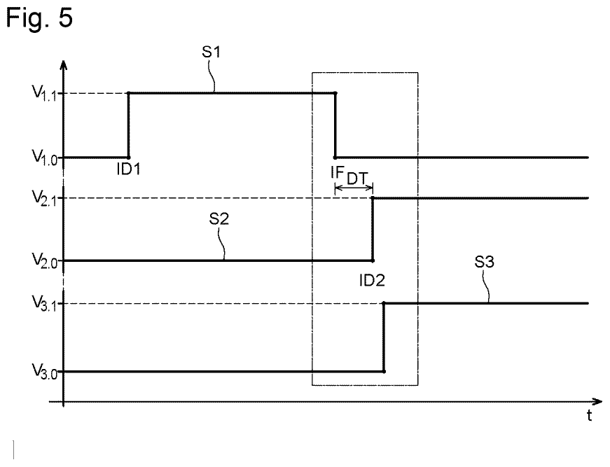

### DETAILED DESCRIPTION OF THE PREFERRED EMBODIMENTS

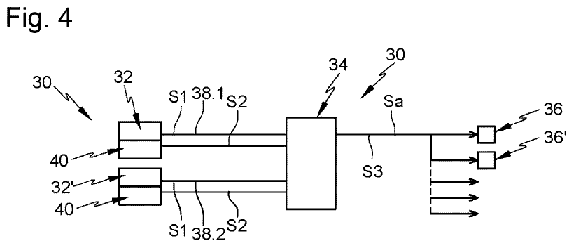

In an embodiment visible in FIG. 4, a fire alert signal detection and management system 30 comprises at least one fire detector 32 configured to generate at least one fire alert signal S1 if heating (caused by a fire, for example) is detected and at least one processing system 34 configured to process each fire alert signal S1 and, depending on the signal or signals received, emitting an alarm signal Sa. The latter is transmitted to audible and/or visual alarms 36 and/or retranscribed onto a display 36′.

The fire alert signal detection and management system 30 comprises, for each fire detector 32, at least one detection channel 38.1 connecting the fire detector 32 to the processing system 34.

In a configuration seen in FIG. 4, the fire alert detection and management system 30 comprises for each detection zone two fire detectors 32, 32′ connected to the processing system 34 by two detection channels 38.1, 38.2, one for each fire detector 32, 32′. In this configuration each pair comprising a fire detector 32, 32′ and a detection channel 38.1, 38.2 is duplicated.

Of course, the invention is not limited to this configuration. In another configuration each fire detector 32 could be connected to the processing system 34 by two detection channels 38.1, 38.2

In one operating mode the fire alert signal S1 has a first (possibly zero) reference value V_{1.0} in the absence of fire and a first detection value V_{1.1} if the fire detector 32 detects a temperature above or equal to a threshold level.

Each fire detector 32 is designed to function for at least a minimal functioning time, on the order of five minutes, in the event of a fire. This minimal functioning time is guaranteed by the manufacturer of the fire detector 32. In practice, the fire detector 32 can have a functioning time greater than the minimal functioning time.

In one embodiment, the first alert signal S1 has a value equal to the first detection value V_{1.1} as long as the temperature detected by the fire detector 32 is at or above the threshold level and the fire detector 32 is functional. If the temperature drops below the threshold level (which corresponds to the end of the fire), or if the fire detector is no longer functional, the fire alert signal S1 has a value equal to the first reference value V_{1.0} or the fire detector 32 no longer emits the fire alert signal S1.

In operation, the fire alert signal S1 starts at a first triggering time ID1, notably if the value of the fire alert signal S1 goes from the first reference value V_{1.0} to the first detection value V_{1.1}, and ends at an end IF, notably if the value of the fire alert signal S1 goes from the first detection value V_{1.1} to the first reference value V_{1.0}.

The processing system 34 is configured to execute a program. In one operating mode this program is configured to combine logically the alert signals coming from the detection channels 38.1, 38.2 and to generate an alarm signal Sa if the value of at least one of the fire alert signals S1 is equal to the reference value V_{1.0}.

The fire alert signal detection and management system 30 comprises, for at least one fire detector 32, a malfunction detection system 40 configured to emit a fault signal S2 if the fire detector 32 is no longer functional or is not functioning correctly. In one operating mode this fault signal S2 has a second, possibly zero, reference value V_{2.0} when the fire detector 32 is functioning correctly and a second detection value V_{2.1} if the fire detector 32 is malfunctioning. In operation, the fault signal S2 starts at a second triggering time ID2, notably when the fault signal S2 goes from the second reference value V_{2.0} to the second detection value V_{2.1}.

In a first embodiment, a system 40 for detecting a malfunction is integrated in the fire detector 32. In this case, the fire detector 32 is configured to emit the fault signal S2 if it malfunctions.

In a second embodiment, the malfunction detection system 40 and the fire detector 32 are two distinct elements. In this case, the malfunction detection system 40 can include, for each fire detector 32, at least one fault detector configured to generate a fault signal S2 if the associated fire detector 32 is malfunctioning.

In either embodiment, a fault signal S2 is generated if the fire detector 32 is malfunctioning. This fault signal S2 can be retranscribed onto a display.

The fire alert signal detection and management system 30 generally comprises a plurality of fire detectors 32, 32′ located in different areas, a processing system 34, detection channels 38.1, 38.2 each connecting one of the fire detectors 32 to the processing system 34, and at least one malfunction determining system 40.

The fire detectors 32, 32′, the processing system 34, the alarms 36, 36′, the detection channels 38.1, 38.2 and the malfunction determining system 40 are not described further because they can be identical to those in the prior art.

According to one feature of the invention, a fire alert signal management method comprises a step of determining a transitory time DT between the end IF of the fire alert signal S1 and the start ID2 of the fault signal S2, a step of comparing the transitory time DT and an alert threshold time, and a step of emitting an alert signal S3 if the transitory time DT is less than or equal to the alert threshold time.

The step of determining the transitory time consists in determining the end IF of the fire alert signal S1, notably its value going from the first detection value V_{1.1} to the first reference value V_{1.0}, and the second triggering time ID2, notably if the fault signal S2 goes from the second reference value V_{2.0} to the second detection value V_{2.1}, and then determining the time between the two times IF and ID2 that corresponds to the transitory time DT.

In one embodiment, the alert threshold time is less than or equal to one minute, preferably less than or equal to 30 seconds.

In one configuration, the alert signal S3 has a third (possibly zero) reference value V_{3.0} if all the fire alert signals S1 are at zero and/or if the transitory time is greater than the alert threshold time and a third detection value V_{3.1}, different from the third reference value V_{3.0}, notably if the transitory time DT is less than or equal to the alert threshold time.

In one embodiment, the fire alert signal management method comprises a step of triggering a visual and/or audible alarm or retranscription onto a display if the alert signal S3 has a value different from the third reference value V_{3.0} and has the third detection value V_{3.1}.

In one operating mode, the fire alert signal management method includes beforehand a step of determining a functioning time of the fire alert signal S1 if the latter has a value equal to the first detection V_{1.1} and, if the functioning time of the fire alert signal S1 is long, finding out if this functioning time is greater than or equal to a functioning threshold time, a step of triggering steps of determining the transitory time DT from the end IF of the fire alert signal S1 and the start ID2 of the fault signal S2 and comparing the transitory time DT and the alert threshold time and then, depending on the comparison step, a step of emitting an alert signal S3.

In one configuration, the functioning threshold time for a fire detector is greater than 60%, preferably between 60% and 90% of the minimal functioning time. The functioning time of the fire alert signal S1 is therefore considered long if the functioning time of the fire alert signal S1 is greater than 60% of the minimal functioning time of the fire detector 32.

In one embodiment, the processing system 34 is configured to compare an alert threshold time and a transitory time DT and then to emit an alert signal if the transitory time DT is less than the alert threshold time.

In one configuration, the processing system 34 is also configured to determine the transitory time DT and a functioning time of the fire alert signal S1 from the fire detector 32 and to compare the functioning time with a functioning threshold time.

In one embodiment, the processing system 34 is configured to execute a program that comprises the following instructions:
a. determining the functioning time of the fire detector 32,
b. comparing the functioning time so determined with a functioning threshold time associated with the fire detector 32,
c. if the functioning time is greater than or equal to the functioning threshold time then the program continues, if not it is halted,
d. determining a transitory time DT between the end IF of the fire alert signal S1 emitted by the fire detector 32 and the start ID2 of the fault signal S2 associated with the fire detector 32,
e. if the transitory time DT is less than the alert threshold time then an alert signal is emitted, if not the program is halted.

In one application, an aircraft engine fire detection and extinction system includes at least one fire alert signal detection and management system 30. In this case, fire detectors 32 are distributed in the main and auxiliary power units of the aircraft. Of course, the invention is not limited to this application. Thus it can be incorporated in all installations or all vehicles including a fire detection system.

Determining a transitory time between the end of the fire alert signal S1 emitted by the fire detector 32 and the start of the fault signal S2 associated with that fire detector 32 and comparing it to an alert threshold time enables reliable and objective determination whether the end of the fire alert signal S1 results from extinction of the fire or from malfunctioning of the fire detector 32. The fire alert signal management method according to the invention enables the crew to be given clear and unambiguous information concerning the presence or not of a fire, even in the event of a malfunctioning of the detection system caused by the fire.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A method of managing fire alert signals coming from a fire detector configured to generate at least one fire alert signal if overheating is detected, a fault signal being generated if the fire detector is malfunctioning, the fire alert signal having an end, the fault signal having a start, wherein the management method comprises the steps of:
determining a transitory time between the end of the fire alert signal and the start of the fault signal,
comparing the transitory time and an alert threshold time, and
emitting an alert signal if the transitory time is less than or equal to the alert threshold time.

2. The fire alert signal management method according to claim 1, wherein the alert threshold time is less than or equal to one minute.

3. The fire alert signal management method according to claim 1, wherein the management method includes, beforehand, the steps of:
determining a functioning time of the fire alert signal,
triggering steps of determining the transitory time, of comparing the transitory time and the alert threshold time, and then, depending on the comparison step,
emitting an alert signal if the functioning time of the fire alert signal is greater than or equal to a functioning threshold time.

4. The fire alert signal management method according to claim 3, wherein the fire detector has a minimal functioning time and the functioning threshold time is between 60% and 90% of the minimal functioning time of the fire detector.

5. The fire alert signal management method according to claim 1, including a step of triggering at least one of a visual alarm, an audible alarm, or a retranscription onto a display if the alert signal is emitted.

6. A fire alert signal detection and management system configured to enable execution of a fire alert signal management method according to claim 1, said system comprising:
a fire detector configured to generate at least one fire alert signal if overheating is detected,
at least one processing system configured to process each fire alert signal and,
for at least the fire detector, a system for detecting a malfunction configured to emit a fault signal if the fire detector is malfunctioning, the fire alert signal having an end, the fault signal having a start,
wherein the processing system is configured to compare an alert threshold time and a transitory time between the end of the fire alert signal and the start of the fault signal and to emit an alert signal if the transitory time is less than the alert threshold time.

7. The fire alert signal detection and management system according to claim 6, wherein the alert threshold time is less than or equal to one minute.

8. The fire alert signal detection and management system according to claim 6, wherein the processing system is configured to determine a functioning time of the fire alert signal from the fire detector and, if the functioning time of the fire alert signal is greater than or equal to a functioning threshold time, to trigger steps of determining the transitory time, comparing the transitory time with the alert threshold time and, depending on the comparison step, emitting an alert signal.

9. The fire alert signal detection and processing system according to claim 8, wherein the fire detector has a minimal functioning time and the functioning threshold time is between 60% and 90% of the minimal functioning time of the fire detector.

10. The fire alert signal detection and management system according to claim 8, wherein the processing system is configured to execute a program that comprises the following instructions:
determining the functioning time of the fire detector,
comparing the functioning time so determined with a functioning threshold time associated with the fire detector,
if the functioning time is greater than or equal to the functioning threshold time then the program continues, if not it is halted,
determining a transitory time between the end of the fire alert signal emitted by the fire detector and the start of the fault signal associated with said fire detector,
if the transitory time is less than the alert threshold time then an alert signal is emitted, if not the program is halted.

11. An aircraft comprising a fire alert signal detection and management system according to claim 6.
